(19) United States
(12) Patent Application Publication
(10) Pub. No.: US 2026/0259058 A1
(43) Pub. Date: Sep. 3, 2026

(54) PARKING LOT MANAGEMENT DEVICE, PARKING LOT MANAGEMENT SYSTEM, PARKING LOT MANAGEMENT METHOD, AND STORAGE MEDIUM

(71) Applicant: HONDA MOTOR CO., LTD., Tokyo (JP)

(72) Inventors: Yuki HARA, Tokyo (JP); Kuniyoshi TANAKA, Tokyo (JP)

(73) Assignee: HONDA MOTOR CO., LTD., Tokyo (JP)

(21) Appl. No.: 19/551,637

(22) Filed: Feb. 27, 2026

(30) Foreign Application Priority Data
Mar. 3, 2025 (JP) 2025-032806

(51) Int. Cl. G01C 21/36

(52) U.S. Cl. CPC G01C 21/3685

(57) ABSTRACT

A parking lot management device identifies, from among a plurality of parking frames, a parking frame to which a user who wishes to use a parking lot provided with the plurality of parking frames is guided. The parking lot management device includes: a processor configured to: identify, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided; and guide the user to the identified parking frame.

### CROSS-REFERENCE TO RELATED APPLICATIONS

This application is based on and claims priority under 35 USC 119 from Japanese Patent Application No. 2025-032806 filed on March 3, 2025, the contents of which are incorporated herein by reference.

### TECHNICAL FIELD

The present disclosure relates to a parking lot management device, a parking lot management system, a parking lot management method, and a storage medium.

### BACKGROUND

In recent years, active efforts have been made to provide access to a sustainable transportation system in consideration of vulnerable traffic participants. As one of these efforts, research and development on driving assistance techniques for vehicles such as automobiles have been made in order to further improve safety and convenience of traffic.

For example, International Patent Application Publication. No. WO2021020384A (hereinafter, referred to as Patent Literature 1) describes a parking assistance system that performs vehicle parking assistance in a parking lot. In the system described in Patent Literature 1, for example, as the remaining fuel or the battery remaining amount decreases, a parking position is set to a parking area closest to a pick-up area or a drop-off area in a parking lot among a plurality of parking areas in the parking lot.

However, even when a user is guided to the parking area closest to the pick-up area or the drop-off area in the parking lot as the parking position as in the configuration of Patent Literature 1, energy consumption may increase. For example, depending on start and stop (stop & go) of the vehicle due to presence of a pedestrian crossing in the parking lot, an operation state of a cooling and heating system, or the like, energy consumption may increase even if a distance from a predetermined position to a parking frame is the shortest.

That is, an energy consumption amount may vary depending on an environment inside the parking lot or the weather environment. Therefore, the parking frame at the shortest distance from the predetermined position is not necessarily the best in view of electric mileage. Therefore, it is desired to identify a parking frame where energy consumption tends to be small in consideration of various environments such as a parking environment.

The present disclosure provides a parking lot management device, a parking lot management system, a parking lot management method, and a storage medium capable of identifying a parking frame where energy consumption tends to be small while considering environments such as a parking environment.

### SUMMARY

A first aspect of the present disclosure relates to a parking lot management device that identifies, from among a plurality of parking frames, a parking frame to which a user who wishes to use a parking lot provided with the plurality of parking frames is guided. The parking lot management device comprising: a processor configured to: identify, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided; and guide the user to the identified parking frame.

A second aspect of the present disclosure relates to a parking lot management system that identifies, from among a plurality of parking frames provided, a parking frame to which a user who wishes to use a parking lot provided with the plurality of parking frames is guided. The parking lot management system includes: a parking lot management device configured to identify the parking frame to which the user is guided; and a vehicle configured to communicate with the parking lot management device and receive guidance to the parking frame. The parking lot management device includes a first controller configured to identify, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided, and guide the user to the identified parking frame, and the vehicle includes a second controller configured to receive the guidance to the parking frame from the parking lot management device, and notify the user of information on the parking frame based on the received guidance.

A third aspect of the present disclosure relates to a non-transitory computer-readable storage medium storing a program for causing a computer to execute a process. The computer identifies, from among a plurality of parking frames, a parking frame to which a user who wishes to use a parking lot provided with the plurality of parking frames is guided, and the process includes: identifying, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided; and guiding the user to the identified parking frame.

The present disclosure can identify a parking frame that reduces energy consumption while considering environments such as a parking environment. This further improves safety of traffic and contributes to development of a sustainable transportation system.

### BRIEF DESCRIPTION OF DRAWINGS

Exemplary embodiments of the present invention will be described in detail based on the following figures, wherein:

FIG. 1 is a block diagram illustrating an example of a configuration of a parking lot management system 100 according to an embodiment;

FIG. 2 is a diagram illustrating an example of energy consumption information 221a;

FIG. 3 is a diagram illustrating an example of environmental information 221b;

FIG. 4 is a sequence chart illustrating an example of processing executed in the embodiment; and

FIG. 5 is a flowchart illustrating an example of processing (parking statistical information update processing) executed in the parking lot management device 200.

### DESCRIPTION OF EMBODIMENTS

Hereinafter, an embodiment will be described with reference to the accompanying drawings. The following embodiment does not limit the present disclosure, and not all of elements described in the following embodiment are necessary to the present disclosure.

Further, two or more elements described in the following embodiment may be freely combined without departing from the gist of the present disclosure. Note that hereinafter, the same or similar elements are denoted by the same or similar reference signs, and description thereof may be omitted or simplified.

### Parking Lot Management System

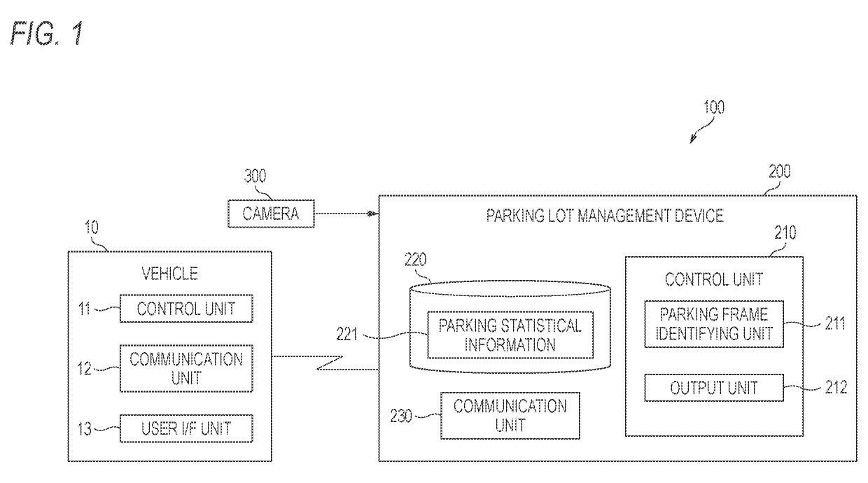

FIG. 1 is a block diagram illustrating an overview of a parking lot management system 100. The parking lot management system 100 is a system that identifies a parking frame where energy consumption tends to be small from among a plurality of parking frames, to which a user who wishes to use a parking lot provided with the plurality of parking frames is guided, and guides the user to the identified parking frame. Note that the energy consumption in the embodiment is mainly power consumption.

The parking lot is, for example, a space in which previously regulated parking frames are provided, and a plurality of vehicles can be parked. Each of the parking frames may be a parking frame having predetermined dimensions, or the dimensions of the parking frame may be determined for each vehicle size such as a small‐sized vehicle including a light automobile and a compact car, a standard-sized (medium‐sized) vehicle, or a large-sized vehicle. The parking lot may include parking frames provided with charging equipment capable of charging a driving battery. Note that the parking lot is assumed to be, for example, a parking lot provided in a commercial facility or the like, a general coin-operated parking space, or the like. The parking lot is also assumed to be, for example, a parking space in a plaza, a riverbed, or an event venue.

The parking lot management system 100 includes a parking lot management device 200 and a vehicle 10, and the parking lot management device 200 and the vehicle 10 can communicate with each other. That is, the parking lot management device 200 and the vehicle 10 cooperate with each other. In the embodiment, as an example, the parking lot management device 200 performs processing of identifying a parking frame to which the user is guided, and the vehicle 10 receives the guidance of the identified parking frame and notifies the user of the parking frame. Note that the vehicle 10 is an electric vehicle equipped with at least a driving battery (that is, a traveling battery). Hereinafter, configurations of the parking lot management device 200 and the vehicle 10 will be described.

### Parking Lot Management Device

The parking lot management device 200 is a device that identifies a parking frame to which the user is guided, and includes, for example, a server device, a general-purpose computer, and the like. The parking lot management device 200 is installed in, for example, a site of a parking lot or a management facility that manages the parking lot.

The parking lot management device 200 is connected to a camera 300 capable of detecting entry and exit of a vehicle into and from the parking lot. The camera 300 may be attached at a position where entry and exit of the vehicle 10 into and from the parking lot can be detected, and is installed, for example, at an entrance or exit of the parking lot. Note that the camera 300 may also serve as a monitoring camera, a security camera, or the like.

The camera 300 only needs to be able to detect at least entry and exit of the vehicle 10 into and from the parking lot, but may also be configured to detect, for example, a parking frame in which the vehicle 10 is parked. The number of the camera 300 is not limited to one, and a plurality of cameras may be installed.

Note that the parking lot management device 200 and the camera 300 may be connected by wired communication or wireless communication, or may be connected via another information processing device or the like.

Information acquired by the camera 300 is output to the parking lot management device 200 and stored in a storage unit 220.

The parking lot management device 200 includes a control unit 210 including a CPU, a RAM, a ROM, and the like, the storage unit 220 including a non-transitory storage medium that stores various types of information, and a communication unit 230. The storage unit 220 stores various programs and various types of data. The communication unit 230 is a circuit for communicating with various vehicles including the vehicle 10 and external devices such as the camera 300 described above. The control unit 210 executes a predetermined program stored in the storage unit 220, the ROM, or the like.

The storage unit 220 stores parking statistical information 221. The parking statistical information 221 includes energy consumption information 221a regarding energy consumption corresponding to each vehicle that was parked in each of the plurality of parking frames in the parking lot (hereinafter, also referred to as "energy consumption information 221a"), and environmental information 221b indicating an environment during parking of each vehicle (hereinafter, also referred to as "environmental information 221b"). The parking frame to which the user is guided is identified based on the parking statistical information 221.

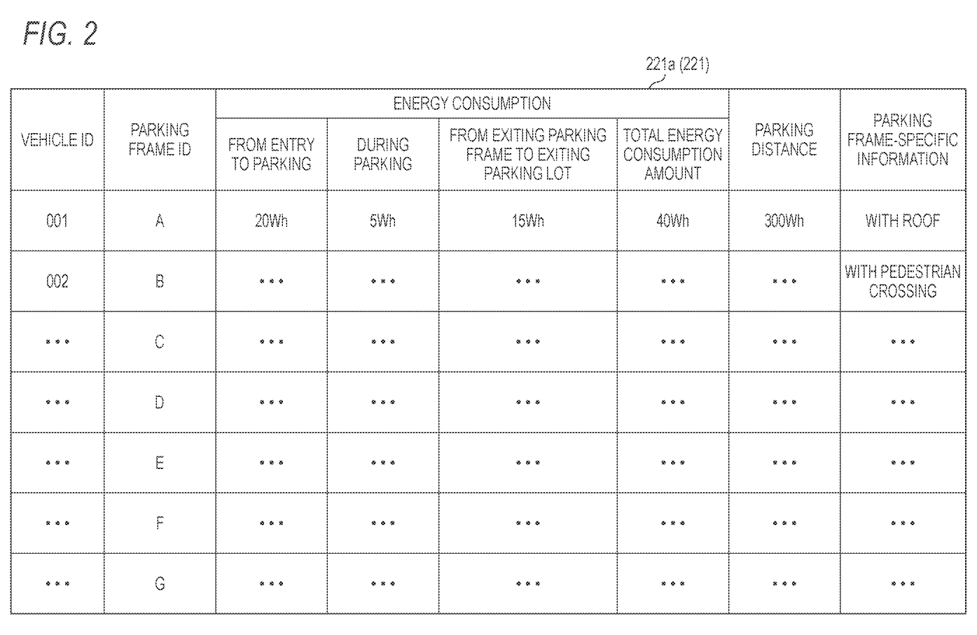

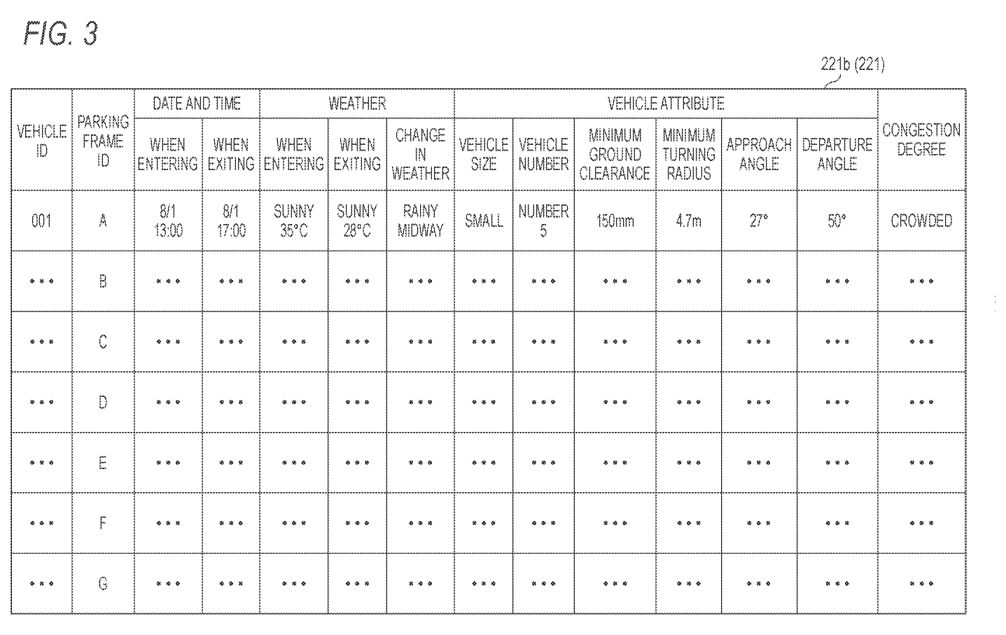

FIGS. 2 and 3 are diagrams illustrating examples of the parking statistical information 221. As described above, the parking statistical information 221 includes the energy consumption information 221a and the environmental information 221b, and here, FIG. 2 illustrates an example of the energy consumption information 221a, and FIG. 3 illustrates an example of the environmental information 221b.

In the energy consumption information 221a illustrated in FIG. 2, information on energy consumption, a parking distance, and parking frame-specific information is stored in association with a vehicle ID and a parking frame ID.

The vehicle ID indicates identification information of a vehicle parked in the parking lot, and is shown by a symbol such as "001".

The parking frame ID indicates identification information of a parking frame, and is shown by a symbol such as "A".

The energy consumption indicates information on energy amounts consumed in the parking lot. Here, the energy consumption is not limited to, for example, power consumption of a battery required for traveling, and includes power consumption due to use of cooling and heating system, power consumption due to use of various devices, and power consumption for performing various types of control.

The energy consumption illustrated in FIG. 2 includes information on energy consumed from entering the parking lot to parking in the parking frame, information on energy consumed during the parking in the parking frame, and information on energy consumed from exiting the parking frame to exiting the parking lot of each vehicle. In the example illustrated in FIG. 2, a total energy consumption amount consumed in the parking lot is also shown.

Note that the "energy consumed from entering the parking lot to parking in the parking frame" means, for example, energy consumption from the vehicle entering the site of the parking lot, traveling on a road in the parking lot, and till completing the parking in the parking frame. The "energy consumed during the parking in the parking frame" means energy consumption after the parking completion and till exiting the parking frame, and the energy consumption here is assumed to be, for example, energy consumption due to use of the cooling and heating system or the like that may be used when a pet such as a dog is made to wait in the vehicle. The "energy consumed from exiting the parking frame to exiting the parking lot" means, for example, energy consumption from exiting the parking frame, traveling on the road in the parking lot, and till exiting the site of the parking lot.

The parking distance indicates a travel distance of each vehicle in the parking lot. That is, a travel distance required from entering the parking lot to parking in the parking frame and a travel distance required from exiting the parking frame to exiting the parking lot are included.

The parking frame-specific information is, for example, information indicating a feature of the parking frame in which the vehicle is parked or a feature on a route to the parking frame. For example, in the example illustrated in FIG. 2, a feature of "with roof" is associated as information corresponding to the parking frame "A". From this information, for example, it is possible to grasp information indicating that a temperature inside the vehicle is less likely to rise as compared with when there is no roof during parking. In addition, the parking frame-specific information may include information on whether there is a pedestrian crossing on a route from a parking lot entrance to the parking frame or a route from the parking frame to a parking lot exit, information on whether charging equipment for a driving battery is disposed in the parking frame, information on a utilization rate of the parking frame, and the like.

Note that the energy consumption information 221a illustrated here is an example, and other information may be included as long as it is information regarding energy consumption. For example, information on a frequency of start and stop (that is, stop&go) on the route until moving to the parking frame may be included. The start and stop of the vehicle may cause a regenerative loss of electric power and the like, and thus may affect electric mileage. The electric mileage means a distance in which the vehicle can travel with an electric power amount of 1 [kWh]. Information on the number of times of direction change on the route to the parking frame and information on a steering amount and the number of times of stationary steering during parking may also be included. This is because, when the steering amount is large, for example, power consumption by an electric power steering mechanism may affect the electric mileage. Information on a friction coefficient of a road surface may also be included. This is because when the friction coefficient of the road surface is high, the electric mileage may be affected. Information on whether there is a shade on the route from the parking lot entrance to the parking frame and the route from the parking frame to the parking lot exit may also be included. This is because the power consumption based on the use of the cooling and heating system may affect the electric mileage depending on the presence or absence of shade. Information on whether there is a gradient or a slope in the parking lot may also be included. This is because the electric mileage may be affected by a regenerative loss of electric power and the like.

Such energy consumption information 221a is, for example, transmitted to and accumulated in the parking lot management device 200 corresponding to the parking of each vehicle. For example, the parking lot management device 200 acquires information on energy consumption in parking of each vehicle and information on a parking distance via the communication unit 230, and stores the acquired information as the energy consumption information 221a. Note that since the parking frame-specific information is information associated with each parking frame in advance, the parking lot management device 200 may store the parking frame-specific information as the energy consumption information 221a in conjunction with acquisition of the parking frame ID from the parked vehicle.

In the environmental information 221b illustrated in FIG. 3, information on date and time, the weather, vehicle attributes, and a congestion degree is stored in association with the vehicle ID and the parking frame ID.

The date and time is information on the date and time when using the parking lot, and includes the date and time when entering the parking lot and the date and time when exiting the parking lot.

The weather is weather information when using the parking lot, and includes weather information when entering the parking lot, weather information when exiting the parking lot, and information on a change in the weather from entry to exit. Here, the weather information may include information on the weather such as "sunny" and "rainy", and information on a temperature. The information on the change in weather is information indicating a change in the weather between entry and exit, or the like, and includes, for example, information such as "rainy on the way", "setting sun is strong", and "temperature changes by a predetermined degrees or more".

The vehicle attributes are information indicating dimensions of the vehicle. The information on the vehicle attributes (hereinafter, also referred to as "attribute information") may affect the electric mileage in identifying the parking frame to which the user is guided. For example, when a vehicle size class of a vehicle is smaller than a predetermined class, it is possible to guide the vehicle to the parking frame with the smallest energy consumption (in other words, with a good electric mileage), but when the vehicle size class of the vehicle is larger than the predetermined class, it is conceivable that the vehicle cannot be guided to the parking frame with the smallest energy consumption for a reason that a width of the parking frame is narrow or the like.

The attribute information of the vehicle includes, for example, information on a vehicle size, a vehicle number, a minimum ground clearance, a minimum turning radius, an approach angle, and a departure angle. Note that each of these pieces of information is an example, and any information with which approximate dimensions of the vehicle can be grasped may be included. In the embodiment, it is preferable that at least one of the vehicle size, the vehicle number, the minimum ground clearance, the minimum turning radius, the approach angle, and the departure angle is included in the attribute information.

The vehicle size is, for example, information indicating dimensions of the vehicle, which is categorized based on an entire length, an entire width, or an entire height of the vehicle. In the embodiment, the vehicle size is regulated and divided into three categories, small, medium, and large. Note that the number of categories is not limited to three, as long as there are a plurality of categories. The vehicle size may be information indicating the dimensions of the vehicle, and may be defined by, for example, the entire length, the entire width, or the entire height of the vehicle.

The vehicle number indicates identification information of the vehicle, and may include at least information indicating the dimensions of the vehicle. In the embodiment, the information indicating the dimensions of the vehicle in the identification information of the vehicle includes the vehicle number indicating a classification of the automobile. For example, information such as "Number 3" indicating an ordinary passenger car or "Number 5" indicating a small passenger car is included.

The minimum ground clearance is information indicating a vertical distance from a horizontal ground surface (road surface) to the lowest portion of a vehicle body.

The minimum turning radius indicates a radius of a circle drawn by a center of the outermost wheel when turning with a steering turned to the maximum. The minimum turning radius is, for example, an index related to ease of turning of the vehicle, that is, can be referred to as an index that affects the electric mileage since the minimum turning radius may affect the steering amount and the number of times of stationary steering.

The approach angle is information indicating an angle between a tangent line drawn from a bottom surface of a front bumper to a ground contact surface of a front wheel and the road surface, and is an index indicating interference between the front bumper and the road surface. That is, the larger the approach angle, the less likely the front bumper is to interfere with the road surface.

The departure angle is information indicating an angle between a tangent line drawn from a bottom surface of a rear bumper to a ground contact surface of a rear wheel and the road surface, and is an index indicating interference between the rear bumper and the road surface. That is, the larger the departure angle, the less likely the rear bumper is to interfere with the road surface.

Note that in the example illustrated in FIG. 3, for example, the information on each of the minimum ground clearance, the minimum turning radius, the approach angle, and the departure angle is indicated by a specific numerical value, but this numerical value may be converted into and stored as a numerical value of a predetermined range when being stored in the storage unit 220. For example, when the minimum ground clearance of a predetermined parked vehicle is 150 [mm], a value of a predetermined range such as 130 [mm] to 170 [mm] may be used. Such value conversion may be performed when, for example, the parking frame to which the user is guided is identified by the control unit 210 described below, in addition to when the value is stored in the storage unit 220.

The attribute information of the vehicle may include, for example, the following information in addition to the above-described information. Information on the vehicle model, information on whether weight distribution of the vehicle is closer to front wheels or rear wheels, information on whether the vehicle has a front wheel steering mechanism or a rear wheel steering mechanism (or a four-wheel steering mechanism), information on whether dimensions of a window or the like that may be affected by sunlight are equal to or larger than predetermined values, tire information (for example, whether tires are sports tires or normal tires), and the like may be included.

The congestion degree indicates information on a congestion degree of vehicles and people in the parking lot during parking, and is shown by a predetermined index such as "crowded", "normal", or "empty". The more crowded the parking lot, the more often the vehicles start and stop, which may affect the electric mileage.

Note that the environmental information 221b illustrated here is an example, and other environmental information may be included as long as it is information that may affect the energy consumption and the electric mileage. For example, information on a route along which each vehicle has traveled in the parking lot (including a route before parking and a route after parking and before exiting the parking lot) may be stored. In this case, the route may be defined by, for example, a link indicating a road in the parking lot, a node indicating an end point, and the like. Information on a change in a power storage amount of the driving battery in the parking lot, information on operating rates of various actuators affected by the electric mileage, and the like may be included.

Such environmental information 221b is, for example, transmitted to and accumulated in the parking lot management device 200 corresponding to the parking of each vehicle. For example, when the camera 300 detects that a vehicle has entered the parking lot, the parking lot management device 200 acquires the attribute information of the vehicle via the communication unit 230. The attribute information of the vehicle may be acquired by communication with each vehicle, or may be acquired based on information acquired by the camera 300 when the attribute information of the vehicle can be acquired by the camera 300. Note that the weather information may be acquired from, for example, an external weather information management system (not illustrated). As the date and time, for example, times at which entry and exit of the vehicle are detected by the camera 300 may be acquired. Similarly, the congestion degree may be acquired based on the information from the camera 300. By acquiring the information regarding the environmental information 221b in this manner, the parking lot management device 200 generates the parking statistical information 221 together with the energy consumption information 221a described with reference to FIG. 2, and stores the generated information in the storage unit 220.

The parking statistical information 221 including the energy consumption information 221a and the environmental information 221b is transmitted to the parking lot management device 200 corresponding to the parking of each vehicle, and thus can be updated at a predetermined circle.

As described above, from the parking statistical information 221 in FIGS. 2 and 3, for example, "various energy consumption amounts, parking distances, parking date and time, weather, vehicle attributes, congestion degrees, and the like when a vehicle with a vehicle ID '001' is parked at a parking frame with a parking frame ID 'A'" can be grasped. Note that the various energy consumption amounts may change according to changes in the vehicle attributes, weather information, and the like. That is, the energy consumption changes depending on the environmental information 221b.

Note that in the parking statistical information 221 illustrated in FIGS. 2 and 3, the parking statistical information of one vehicle in each parking frame such as the parking frame ID "A" is shown, but it can be assumed that a plurality of vehicles have been parked in each parking frame such as the parking frame "A". Therefore, although not illustrated here, parking statistical information of a plurality of vehicles in each parking frame may be stored. In this case, for example, a total energy consumption amount may be averaged for each parking frame, and ranking may be performed so as to grasp which parking frame has relatively small energy consumption. Further, since the rank may change depending on a weather condition or the like, the same ranking may be performed for each condition.

In the embodiment, the energy consumption information 221a and the environmental information 221b are described separately in FIGS. 2 and 3 for convenience of description, but these pieces of information may be integrated into one piece of information. The parameters included in the energy consumption information 221a may be defined by the environmental information 221b. For example, the parking frame-specific information included in the energy consumption information 221a in FIG. 2 may be defined by the environmental information 221b in FIG. 3. Similarly, the parameters included in the environmental information 221b may be defined by the energy consumption information 221a.

The control unit 210 executes various programs stored in the storage unit 220. In the related art, a configuration is known in which a vehicle is guided to a parking frame closest to a predetermined position as a parking position as the remaining energy amount of the vehicle decreases (for example, Patent Literature 1 mentioned above), but even in such a case, energy consumption may increase. For example, when a pedestrian crossing is present in the parking lot, a frequency of start and stop of the vehicle may increase, and energy consumption may increase. For example, energy consumption may increase depending on an operation state of the cooling and heating system. Therefore, even if a distance from the predetermined position to the parking frame is the shortest, energy consumption may increase. That is, the energy consumption amount may vary depending on an environment inside the parking lot or the weather environment. That is, the parking frame at the shortest distance from the predetermined position is not necessarily the best in view of the electric mileage. Therefore, in the embodiment, a predetermined program for identifying a parking frame where the energy consumption tends to be small in consideration of various environments such as a parking environment is executed.

Specifically, the control unit 210 includes a parking frame identifying unit 211 and an output unit 212 as functional units implemented by executing predetermined programs. Note that, in the following, processing described as being performed by the parking frame identifying unit 211 and the output unit 212 is processing implemented by the control unit 210.

The parking frame identifying unit 211 identifies a parking frame to which the user is guided. Specifically, based on the parking statistical information 221 including the energy consumption information 221a and the environmental information 221b described above, the parking frame identifying unit 211 identifies a parking frame where the energy consumption is smaller than a predetermined value as the parking frame to which the user is guided. Here, the "predetermined value" may be, for example, a value determined in advance by an experiment or the like. Alternatively, the predetermined value may be replaced by an event such as "a parking frame where the energy consumption is the smallest in the parking lot". That is, the parking frame where the energy consumption is the smallest in the parking lot may be identified as the parking frame to which the user is guided. Note that, in the case of identifying a parking frame where the energy consumption is smaller than the predetermined value, it is assumed that a plurality of parking frames that can be candidates are identified, but in that case, the parking frame identifying unit 211 may identify a plurality of parking frames. On the other hand, if the number of parking frames to be identified is too large, it may be troublesome for the guided user to select one parking frame, and in this case, for example, a configuration may be adopted in which a predetermined number of parking frames are identified, such as the top three parking frames with the smallest energy consumption may be identified from among the target parking frames.

When identifying the parking frame to which the user is guided, the parking frame identifying unit 211 may simply identify the parking frame where the energy consumption is smaller than the predetermined value with reference to the parking statistical information 221, but it is preferable to identify the parking frame according to environments such as a vehicle size class of the vehicle 10 of the user and the weather during parking. For example, the parking frame identifying unit 211 refers to the environmental information 221b to identify an environment similar to the environment when the vehicle 10 of the user enters the parking lot, and identifies a parking frame where the energy consumption is smaller than the predetermined value in the identified environment as the parking frame to which the user is guided.

More specifically, first, the parking frame identifying unit 211 acquires entry information of the vehicle 10 of the user into the parking lot based on the information detected by the camera 300. Then, the attribute information of the vehicle 10 is acquired by communication with the vehicle 10. Note that the attribute information may be the same as the attribute information included in the environmental information 221b described above with reference to FIG. 3. The acquisition of the attribute information may be based on imaging by the camera 300 in addition to communication with the vehicle 10. Then, the parking frame identifying unit 211 also acquires the weather information during entry of the vehicle 10 into the parking lot from a weather management system or the like while acquiring the attribute information of the vehicle 10. The parking frame identifying unit 211 identifies an environment similar to the environment of the vehicle 10 with reference to the environmental information acquired from the vehicle 10 and the environmental information 221b in the parking statistical information 221. Here, the "environment similar" does not necessarily mean that attribute information such as the vehicle size, the weather, and the like match with each other, and may be regarded as being similar when, for example, conditions of a predetermined number or more of parameters among a plurality of parameters match each other. Note that the definition of such a similar environment may be defined by, for example, a manufacturer or the like.

After identifying the environment similar to the environment when the vehicle 10 enters the parking lot, the parking frame identifying unit 211 extracts a parking frame where the energy consumption is smaller than the predetermined value in the identified environment, and sets the extracted parking frame as the parking frame to which the user is guided. As a result, it is possible to guide the user to a parking frame suitable for the environment when the user enters the parking lot, and for example, it is possible to identify a parking frame suitable for the vehicle 10 of the user and guide the user to the parking frame as compared with the case of simply identifying a parking frame where the energy consumption is small.

Note that the parking frame identifying unit 211 may predict the weather or the like when the vehicle 10 exits the parking lot from the environment when entering, and identify the parking frame to which the user is guided also in consideration of the environment when exiting. In this case, the parking frame identifying unit 211 may refer to the environmental information 221b to identify a parking frame also suitable for the environment when exiting the parking lot in addition to the environment when entering the parking lot described above. That is, the parking frame identifying unit 211 may refer to the environmental information 221b to identify a predicted congestion degree from when entering the parking lot to when exiting the parking lot and a change in the weather from when entering the parking lot to when exiting the parking lot, and identify the parking frame where the energy consumption is smaller than the predetermined value in consideration of these pieces of information.

It is preferable that the parking frame identifying unit 211 acquires information on the parking frame selected by the user according to a result of guidance by a function of the output unit 212 described below, and updates the parking statistical information 221 based on the acquired information on the parking frame. This is because, by acquiring the information on the selected parking frame and reflecting the information in the parking statistical information 221, the information is updated to accurate information, and a parking frame to which the user is guided will be identified based on the updated information. When the vehicle 10 exits the parking lot, the parking frame identifying unit 211 acquires information on energy consumption of the vehicle 10 in the parking lot and updates the parking statistical information 221 by reflecting the information. That is, the information on the energy consumed from when the vehicle 10 enters the parking lot to when the vehicle 10 exits the parking lot is acquired, and the information is reflected in the parking statistical information 221. Note that the information on the energy consumed from when entering the parking lot to when exiting the parking lot may be the same as the energy consumption described with reference to FIG. 2, that is, may include information on the energy consumption from the entry to the parking, during the parking, and from exiting the parking frame to exiting the parking lot.

In this way, when the parking statistical information 221 is updated, the parking frame identifying unit 211 identifies the parking frame where the energy consumption is smaller than the predetermined value as the parking frame to which the user is guided based on the updated parking statistical information 221.

Note that the processing of identifying the parking frame where the energy consumption is smaller than the predetermined value may be performed, for example, when the remaining energy amount, that is, the battery remaining amount of the vehicle 10 when entering the parking lot is less than a threshold. This is because, in a state in which the battery remaining amount of the vehicle 10 has a relatively large margin, there is a possibility that the user prefers to be guided to a parking frame close to a predetermined position such as an entrance or an exit, or a pick-up or drop-off area of the parking lot than to be guided to a parking frame where the energy consumption is small. In other words, the parking frame identifying unit 211 guides the user to the parking frame focusing on the electric mileage when the battery remaining amount is less than the threshold, and guides the user to the parking frame focusing on the distance when the battery remaining amount is equal to or greater than the threshold.

For example, when there is no available energy charging equipment (that is, battery charging equipment) in the parking lot, the parking frame identifying unit 211 may be configured to identify the parking frame where the energy consumption is smaller than the predetermined value. This is because, the number of facilities having charging equipment is relatively smaller than that of refueling stations such as gas stations, and when a battery cannot be charged in a parking lot, a possibility of running out of power during traveling may be assumed. In other words, when there is charging equipment in the parking lot, the parking frame may be identified focusing on the distance, and when there is no charging equipment in the parking lot, the parking frame may be identified focusing on the electric mileage.

Note that a configuration may be adopted in which, for example, whether to identify a parking frame focusing on the electric mileage or to identify a parking frame focusing on the distance may be set by the user according to the battery remaining amount or the presence or absence of charging equipment.

The output unit 212 guides the user to the parking frame identified by the function of the parking frame identifying unit 211. That is, the output unit 212 transmits information on the parking frame identified by the parking frame identifying unit 211 to the vehicle 10 via the communication unit 230. The transmitted information is received by the vehicle 10. The vehicle 10 guides the user to the parking frame by notifying the user of the parking frame by a predetermined means such as displaying the parking frame on a predetermined display unit such as a touch panel or outputting the parking frame by voice. Note that the display unit as a notification destination is, for example, a portable terminal such as a smartphone of the user.

### Vehicle

Next, a configuration of the vehicle 10 of the user who receives the guidance to the parking frame from the parking lot management device 200 will be described. As described above, the vehicle 10 is an electric vehicle including the driving battery (not illustrated). Therefore, the vehicle 10 is assumed to be an electric automobile provided with a motor as a drive source, or a hybrid vehicle provided with an engine and a motor as the drive sources. Further, the vehicle 10 is a vehicle having a function of notifying the user of the parking frame by displaying the guidance of the parking frame received from the parking lot management device 200 on a predetermined display unit or the like. That is, the vehicle is a vehicle capable of parking assistance (or driving assistance) of at least notifying the user of the parking frame. Note that the vehicle may be a vehicle having other functions such as predetermined driving assistance and automatic driving.

As illustrated in FIG. 1, the vehicle 10 includes a control unit 11, a communication unit 12, and a user I/F unit 13. The control unit 11 is a computer including a CPU, a RAM, a ROM, and the like.

The communication unit 12 includes a circuit for communicating with other devices. In the embodiment, the vehicle 10 can communicate with the parking lot management device 200 via the communication unit 12, and exchanges various types of information. For example, the vehicle 10 receives the guidance of the parking frame from the parking lot management device 200, and transmits the attribute information of the vehicle 10, information on the parking frame in which the vehicle is parked, and the like to the parking lot management device 200.

The user I/F unit 13 is an interface unit for inputting an instruction of the user and providing various types of information to the user, and includes a display unit including a touch panel display (not illustrated), an input unit such as a switch, and an output unit such as a speaker. In the embodiment, the information on the parking frame transmitted from the parking lot management device 200 is displayed on the display unit of the user I/F unit 13 or output from the speaker.

The control unit 11 can execute a predetermined program stored in a storage unit (not illustrated) or the like. For example, the control unit 11 executes a predetermined program for guiding the user to the parking frame. Specifically, the control unit 11 receives the information on the parking frame transmitted from the parking lot management device 200, and performs control to display the received information on the parking frame on the display unit of the user I/F unit 13. When the displayed parking frame is selected by the user, the control unit 11 may perform control such as displaying a route to the parking frame and performing guidance.

### Sequence Chart

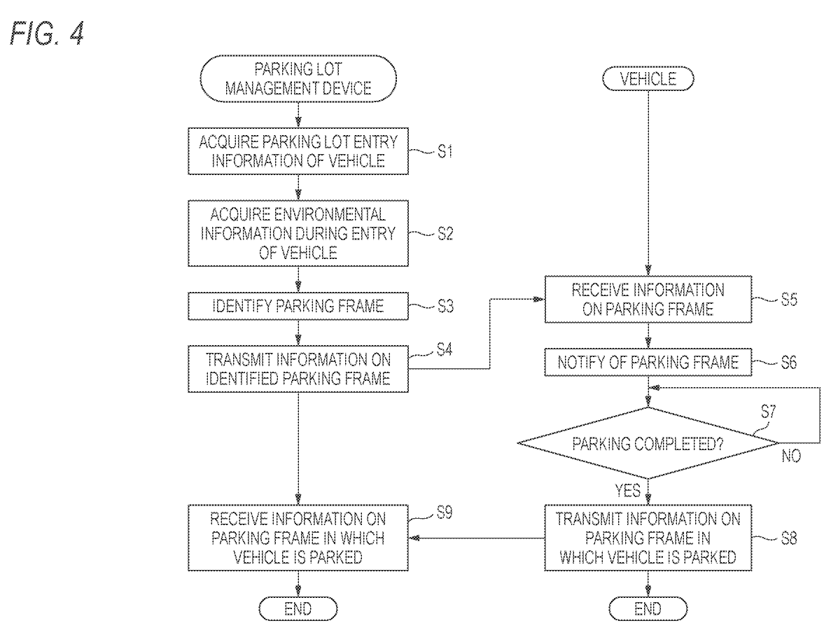

Next, an example of processing executed in the embodiment will be described with reference to a sequence chart. FIG. 4 is a sequence chart illustrating an example of the processing, and the parking lot management device 200 and the vehicle 10 cooperate to perform the processing. As described above, the parking lot management device 200 identifies a parking frame to which the user is guided and transmits information on the identified parking frame to the vehicle 10. The vehicle 10 displays the guidance of the parking frame received from the parking lot management device 200 on the display unit or the like. Note that since a specific content of each processing in the parking lot management device 200 and the vehicle 10 is as described above, here, the flow of the processing will be mainly described, and the detailed description of the processing will be omitted or simplified.

First, in step S1, the control unit 210 in the parking lot management device 200 acquires parking lot entry information of the vehicle 10. That is, the control unit 210 acquires information indicating that the vehicle 10 has entered the parking lot, and starts identifying the parking frame to which the user is guided with the acquisition of the parking lot entry information as a trigger. Specifically, the information indicating that the vehicle 10 has entered the parking lot is acquired by the camera 300. Then, the control unit 210 acquires the information indicating that the vehicle 10 has entered the parking lot from the camera 300 via the communication unit 230.

Next, in step S2, the control unit 210 acquires the environmental information when the vehicle 10 enters the parking lot. That is, the attribute information such as the vehicle size, vehicle number, minimum ground clearance, minimum turning radius, approach angle, and departure angle of the vehicle 10, and the weather information when the vehicle 10 enters the parking lot are acquired. Note that the attribute information of the vehicle 10 may be acquired by communication with the vehicle 10, or, for example, when the vehicle 10 enters the parking lot in step S1, the vehicle size and the like may be acquired by the camera 300 together with the information indicating that the vehicle 10 has entered the parking lot. As described above, the weather information may be acquired by, for example, communication with a weather management system or the like.

Next, in step S3, the control unit 210 identifies the parking frame to which the user is guided. Specifically, based on the parking statistical information 221 including the energy consumption information 221a and the environmental information 221b described above, the control unit 210 identifies a parking frame where the energy consumption is smaller than the predetermined value as the parking frame to which the user is guided. In this case, the control unit 210 may refer to the environmental information 221b to identify an environment similar to the environment when the vehicle 10 enters the parking lot, and identify a parking frame where the energy consumption is smaller than the predetermined value in the identified environment as the parking frame to which the user is guided. Note that in this case, a plurality of parking frames may be identified as described above.

As described above, the parking frame to which the user is guided may be identified in consideration of the battery remaining amount of the vehicle 10 and the presence or absence of charging equipment in the parking lot.

Next, in step S4, the control unit 210 transmits the information on the parking frame identified in step S3 to the vehicle 10. That is, the control unit 210 transmits the information on the identified parking frame to the vehicle 10 via the communication unit 230. As a result, it is possible to transmit the information on the parking frame to which the user is guided. Note that the control unit 210 may transmit the information on the route to the parking frame together with the transmission of the information on the parking frame. After transmitting the information on the parking frame to the vehicle 10, the control unit 210 may store the transmitted information on the parking frame in the storage unit 220 or may store the transmitted information on the parking frame as a part of the parking statistical information 221.

According to the processing of step S4, the vehicle 10 receives the information on the parking frame from the parking lot management device 200 (step S5). That is, the control unit 11 in the vehicle 10 acquires the information on the parking frame to which the user is guided from the parking lot management device 200 via the communication unit 12.

Then, the vehicle 10 notifies the user of the information on the parking frame received in step S5 (step S6). For example, the control unit 11 displays the information on the parking frame on the display unit in the user I/F unit 13. Alternatively, the user may be notified of the information on the parking frame via a speaker in the user I/F unit 13. As a result, the user can select the parking frame based on the displayed information on the parking frame.

Then, the vehicle 10 determines whether the parking of the vehicle 10 is completed (step S7). For example, the control unit 11 determines that the parking is completed based on that a shift device (not illustrated) is in a parking range in the parking lot.

When it is determined that the parking of the vehicle 10 is not completed yet (No in step S7), the control unit 11 waits until it is determined that the parking is completed.

On the contrary, when it is determined that the parking of the vehicle 10 is completed (Yes in step S7), the control unit 11 transmits information on the parking frame in which the vehicle 10 is parked to the parking lot management device 200 (step S8).

According to the processing of step S8, the parking lot management device 200 receives the information on the parking frame in which the vehicle 10 is parked from the vehicle 10 (step S9). That is, the control unit 210 acquires the information on the parking frame in which the vehicle 10 is parked from the vehicle 10 via the communication unit 230. Then, after acquiring the information on the parking frame in which the vehicle 10 is parked, the parking lot management device 200 updates the parking statistical information 221 by reflecting the information.

Note that when the information on the parking frame in which the vehicle 10 is parked can be acquired by, for example, imaging information of the camera 300, the control unit 210 may acquire the information on the parking frame in which the vehicle 10 is parked by communication with the camera 300. In this case, the processing of step S8 may be omitted.

### Parking Statistical Information Update Processing

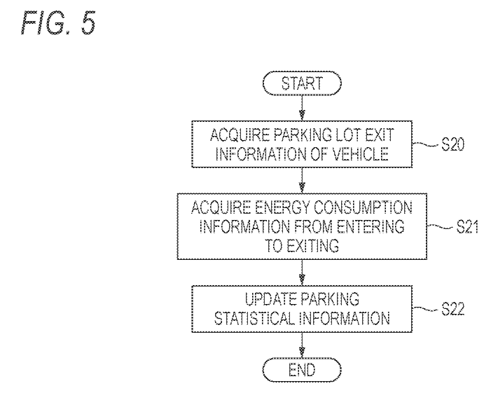

Next, the processing of updating the parking statistical information 221 by reflecting the energy consumption information performed by the parking lot management device 200 will be described. FIG. 5 is a flowchart illustrating an example of the update processing. In the example illustrated here, the control unit 210 acquires the information on the energy consumed from when the vehicle 10 enters the parking lot to when the vehicle 10 exits the parking lot and performs updating.

First, the control unit 210 acquires parking lot exit information of the vehicle 10 (step S20). For example, the control unit 210 acquires information indicating that the vehicle 10 has exited the parking lot based on the imaging information of the camera 300. That is, the control unit 210 acquires the information indicating that the vehicle 10 has exited the parking lot from the camera 300 via the communication unit 230.

Next, the control unit 210 acquires the information on the energy consumed from when the vehicle 10 enters the parking lot to when the vehicle 10 exits the parking lot (step S21). Here, as described above, the information on the energy consumed from entry to exit includes the information on the energy consumed from when the vehicle 10 enters the parking lot to when the vehicle 10 is parked in the parking frame, the information on the energy consumed during parking in the parking frame, and the information on the energy consumed from when the vehicle 10 exits the parking frame to when the vehicle 10 exits the parking lot. The control unit 210 acquires each piece of information on the energy consumed from the vehicle 10 via the communication unit 230.

Next, the control unit 210 updates the parking statistical information 221 (step S22). That is, the control unit 210 reflects the information on the energy consumed from when the vehicle 10 enters the parking lot to when the vehicle 10 exits the parking lot acquired in step S21 in the energy consumption information 221a, and updates the parking statistical information 221.

As described above, by updating the parking statistical information 221, the parking frame to which the user is guided is identified based on the updated parking statistical information 221. As a result, the parking frame to which the user is guided can be identified based on the parking statistical information 221 with high accuracy.

### Effects of Embodiment

As described above, in the embodiment, the parking lot management device 200 identifies the parking frame where the energy consumption is smaller than the predetermined value as the parking frame to which the user is guided based on the parking statistical information 221 including the energy consumption information 221a and the environmental information 221b indicating the environment during parking. That is, in the embodiment, the parking frame where the energy consumption is smaller than the predetermined value is identified in consideration of various events and situations during parking. Accordingly, for example, as compared with a configuration in which the user is guided to the parking frame having the shortest distance from a predetermined position such as an entrance or an exit, or a pick-up or drop-off area of the parking lot, it is possible to guide the user to a parking frame having smaller energy consumption. That is, even in the case where the user is guided to a parking frame having the shortest distance from a predetermined position, if there is a pedestrian crossing on the path to the parking frame or the vehicle is easily affected by sunlight in the parking frame, the power consumption amount may increase, but in the embodiment, it is possible to identify the parking frame where the energy consumption is small and guide the user to the parking frame in consideration of such events and situations.

Then, the user who is guided to the parking frame can save the trouble of searching for the parking frame suitable for the vehicle 10 of the user. In this way, since the user can be guided to an appropriate parking frame with reference to parking tendency of each vehicle (in other words, each user), for example, when similar processing is performed, it is possible to reduce the cost for introducing a sensor, a device, or the like for acquiring the environment of the parking lot and the like.

In the embodiment, the parking lot management device 200 refers to the environmental information 221b to identify an environment similar to the environment when the vehicle 10 enters the parking lot, and identifies a parking frame where the energy consumption is smaller than the predetermined value in the identified environment as the parking frame to which the user is guided. As a result, it is possible to guide the user to a parking frame where the energy consumption is smaller than the predetermined value and suitable for the vehicle size class such as the vehicle size, and the environment of the vehicle 10 such as the current weather.

The environmental information 221b includes the information indicating the congestion degree in the parking lot, the information on the date and time when the vehicle 10 exits the parking lot, the information indicating a change in the weather from when the vehicle 10 enters the parking lot to when the vehicle 10 exits the parking lot, and the like. Therefore, by identifying the parking frame to which the user is guided in consideration of these pieces of information, it is possible to guide the user to the parking frame where the energy consumption is smaller than the predetermined value and more suitable for the environment of the vehicle 10 of the user.

In the embodiment, the parking lot management device 200 acquires the information on the parking frame selected according to the result of the guidance by the function of the output unit 212, and updates the parking statistical information 221 based on the acquired information on the parking frame. Then, based on the updated parking statistical information 221, a parking frame where the energy consumption is smaller than the predetermined value is identified as a parking frame to which the user is guided. Accordingly, it is possible to identify a parking frame to which the user is guided based on more accurate information.

In the embodiment, if the remaining amount of the driving battery when the vehicle 10 enters the parking lot is less than a threshold, the parking lot management device 200 identifies a parking frame where the energy consumption is smaller than the predetermined value as the parking frame to which the user is guided. In other words, if the battery remaining amount when the vehicle 10 enters the parking lot is equal to or higher than the threshold, the user may be guided to a parking frame other than the parking frame focusing on the energy consumption. In this case, for example, a parking frame having the shortest distance from a predetermined position such as an entrance or an exit, or a pick-up or drop-off area of the parking lot is identified. That is, it is possible to guide the user to a parking frame focusing on electric mileage or distance according to the battery remaining amount.

In the embodiment, if there is no charging equipment for the driving battery in the parking lot, the parking lot management device 200 identifies a parking frame where the energy consumption is smaller than the predetermined value as the parking frame to which the user is guided. That is, if there is charging equipment in the parking lot, the user can charge the battery in the parking lot, but if there is no charging equipment in the parking lot, the user needs to charge the battery outside the parking lot. The number of facilities provided with charging equipment is smaller than that of refueling stations such as gas stations. Therefore, in the embodiment, if there is no charging equipment for the battery in the parking lot, it is possible to reduce the possibility that the vehicle 10 runs out of power by identifying a parking frame where the energy consumption is smaller than the predetermined value and guiding the user to the parking frame.

Although the embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure. In addition, constituent elements in the embodiment described above may be freely combined without departing from the gist of the present disclosure.

For example, in the above-described embodiment, when identifying the parking frame to which the user is guided, the parking lot management device 200 may acquire, for example, vacancy information of parking frames in the current parking lot in addition to the parking statistical information 221, and identify the parking frame to which the user is guided in consideration of the vacancy information. For example, the parking lot management device 200 may be configured to acquire the vacancy information of the parking frames based on the information acquired by the camera 300, or may be configured to acquire a vacancy situation by communication with a device that manages the vacancy situation of the parking frame or the like. Accordingly, for example, it is possible to avoid a situation in which the parking frame to which the user is guided is occupied, and it is possible to guide the user to a more appropriate parking frame.

The configurations of the above-described embodiment may share functions or may be implemented by fewer devices and the like. For example, at least a part of the configurations of the parking lot management device 200 may be implemented by the vehicle 10 or the like.

For example, at least a part of units (the parking frame identifying unit 211 and the output unit 212) constituting the control unit 210 of the parking lot management device 200 may be separated and present in a plurality of devices. For example, the parking lot management device 200 may be implemented by a cloud server or the like.

Further, a part of the configurations of the above-described embodiment may be omitted, or the processing may be changed or omitted.

The processing described in the above embodiment can be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present description, at least the following matters are described. Although corresponding constituent elements in the embodiment described above are shown in parentheses, the present disclosure is not limited thereto.

(1) A parking lot management device (parking lot management device 200) that identifies a parking frame, from among a plurality of parking frames, to which a user who wishes to use a parking lot provided with the plurality of parking frames is guided, the parking lot management device including:

a parking frame identifying unit (parking frame identifying unit 211) configured to, based on parking statistical information (parking statistical information 221) including energy consumption information (energy consumption information 221a) regarding energy consumption corresponding to each vehicle that was parked in each of the plurality of parking frames in the parking lot, and environmental information (environmental information 221b) indicating an environment during parking of each vehicle, identify a parking frame where the energy consumption is smaller than a predetermined value as the parking frame to which the user is guided; and

an output unit (output unit 212) configured to guide the user to the identified parking frame.

According to (1), the parking frame where the energy consumption is smaller than the predetermined value is identified as the parking frame to which the user is guided based on the parking statistical information including the energy consumption information and the environmental information indicating the environment during parking. Accordingly, for example, as compared with a configuration in which the user is guided to a parking frame at the shortest distance from a predetermined position or the like, it is possible to guide the user to a parking frame where the energy consumption is smaller. That is, it is possible to identify the parking frame where the energy consumption is small and to guide the user to the parking frame taking into consideration environments such as the parking environment.

(2) The parking lot management device according to (1), in which

the environmental information includes attribute information indicating an attribute of each vehicle, information indicating entry date and time into the parking lot, and weather information during entry into the parking lot, and

the parking frame identifying unit is configured to identify an environment similar to an environment during entry of a vehicle (vehicle 10) of the user into the parking lot with reference to the environmental information, and identify a parking frame where the energy consumption is smaller than the predetermined value in the identified environment as the parking frame to which the user is guided to.

According to (2), it is possible to guide the user to a parking frame where the energy consumption is smaller than the predetermined value and suitable for the vehicle size class of the vehicle of the user, and the environment such as the current weather.

(3) The parking lot management device according to (1), in which

the environmental information further includes information indicating exit date and time from the parking lot, information indicating a congestion degree in the parking lot from entry to exit, and information indicating a change in weather from the entry to the exit.

According to (3), the parking frame to which the user is guided is identified in consideration of the information on exit from the parking lot in addition to the information on entry into the parking lot. Accordingly, for example, it is possible to guide the user to a parking frame where the energy consumption is smaller than the predetermined value and more suitable for the environment of the vehicle of the user than the configuration in (2).

(4) The parking lot management device according to (2), in which

the weather information includes at least information on weather and temperature.

According to (4), by identifying the parking frame to which the user is guided while taking into consideration the weather and temperature, it is possible to more accurately identify the parking frame where the energy consumption is smaller than the predetermined value and guide the user to the parking frame.

(5) The parking lot management device according (2), in which

the attribute information includes at least one of a vehicle size, a minimum ground clearance, a minimum turning radius, a vehicle number, an approach angle, and a departure angle.

According to (5), since the attribute information such as the vehicle size is included in the environmental information, for example, it is possible to identify the parking frame where the energy consumption is small and guide the user to the parking frame based on the information on the energy consumption of the vehicle size similar to that of the vehicle of the user.

(6) The parking lot management device according to (1) or (2), in which

the parking frame identifying unit is configured to

acquire information on a parking frame selected according to a guidance result provided by the output unit, and update the parking statistical information based on the acquired information on the parking frame, and

identify a parking frame where the energy consumption is smaller than the predetermined value as the parking frame to which the user is guided based on the updated parking statistical information.

According to (6), it is possible to identify the parking frame to which the user is guided based on more accurate information by identifying the parking frame where the energy consumption is smaller than the predetermined value based on the updated parking statistical information.

(7) The parking lot management device according to (1) or (2), in which

the parking frame identifying unit is configured to identify a parking frame where the energy consumption is smaller than the predetermined value as the parking frame to which the user is guided when a remaining energy amount of a vehicle of the user during entry into the parking lot is less than a threshold.

According to (7), it is possible to guide the user to a parking frame according to a state of the vehicle of the user by identifying the parking frame where the energy consumption is smaller than the predetermined value when the remaining energy amount of the vehicle of the user is less than the threshold.

(8) The parking lot management device according to (1) or (2), in which

the parking frame identifying unit is configured to identify a parking frame where the energy consumption is smaller than the predetermined value as the parking frame to which the user is guided when there is no available energy charging equipment in the parking lot.

According to (8), it is possible to guide the user to a parking frame according to the parking environment by identifying the parking frame where the energy consumption is smaller than the predetermined value when there is no available energy charging equipment in the parking lot.

(9) The parking lot management device according to (1) or (2), in which

the energy consumption information includes information on energy consumption of each vehicle from entering the parking lot to parking in the parking frame, information on energy consumption during parking in the parking frame, and information on energy consumption from exiting the parking frame to exiting the parking lot.

According to (9), the energy consumption information includes the information on the energy consumption corresponding to each situation from when entering the parking lot to exiting the parking lot, so that a more accurate energy consumption amount during parking can be grasped, and the parking frame to which the user is guided can be identified based on the information.

(10) A parking lot management system (parking lot management system 100) that identifies a parking frame, from among a plurality of parking frames, to which a user who wishes to use a parking lot provided with the plurality of parking frames is guided, the parking lot management system including:

a parking lot management device (parking lot management device 200) configured to identify the parking frame to which the user is guided; and

a vehicle (vehicle 10) configured to communicate with the parking lot management device and receive guidance to the parking frame, in which

the parking lot management device includes a first control unit (control unit 210) configured to, based on parking statistical information (parking statistical information 221) including energy consumption information (energy consumption information 221a) regarding energy consumption corresponding to each vehicle that was parked in each of the plurality of parking frames in the parking lot, and environmental information (environmental information 221b) indicating an environment during parking of each vehicle, identify a parking frame where the energy consumption is smaller than a predetermined value as the parking frame to which the user is guided, and guide the user to the identified parking frame, and

the vehicle includes a second control unit (control unit 11) configured to receive the guidance to the parking frame from the parking lot management device, and notify the user of information on the parking frame based on the received guidance.

According to (10), the parking frame where the energy consumption is smaller than the predetermined value is identified as the parking frame to which the user is guided based on the parking statistical information including the energy consumption information and the environmental information indicating the environment during parking. Accordingly, for example, as compared with a configuration in which the user is guided to a parking frame at the shortest distance from a predetermined position or the like, it is possible to guide the user to a parking frame where the energy consumption is smaller. That is, it is possible to identify the parking frame where the energy consumption is small and to guide the user to the parking frame taking into consideration environments such as the parking environment. Then, the user who is guided to the parking frame can save the trouble of searching for the parking frame suitable for the vehicle of the user.

(11) A parking lot management method, in which

a computer that identifies a parking frame, from among a plurality of parking frames, to which a user who wishes to use a parking lot provided with the plurality of parking frames is guided, executes processing of

based on parking statistical information (parking statistical information 221) including energy consumption information (energy consumption information 221a) regarding energy consumption corresponding to each vehicle that was parked in each of the plurality of parking frames in the parking lot, and environmental information (environmental information 221b) indicating an environment during parking of each vehicle, identifying a parking frame where the energy consumption is smaller than a predetermined value as the parking frame to which the user is guided, and

guiding the user to the identified parking frame.

According to (11), the parking frame where the energy consumption is smaller than the predetermined value is identified as the parking frame to which the user is guided based on the parking statistical information including the energy consumption information and the environmental information indicating the environment during parking. Accordingly, for example, as compared with a configuration in which the user is guided to a parking frame at the shortest distance from a predetermined position or the like, it is possible to guide the user to a parking frame where the energy consumption is smaller. That is, it is possible to identify the parking frame where the energy consumption is small and to guide the user to the parking frame taking into consideration environments such as the parking environment.

(12) A program, causing a computer that identifies a parking frame, from among a plurality of parking frames, to which a user who wishes to use a parking lot provided with the plurality of parking frames is guided, to execute processing of

based on parking statistical information (parking statistical information 221) including energy consumption information (energy consumption information 221a) regarding energy consumption corresponding to each vehicle that was parked in each of the plurality of parking frames in the parking lot, and environmental information (environmental information 221b) indicating an environment during parking of each vehicle, identifying a parking frame where the energy consumption is smaller than a predetermined value as the parking frame to which the user is guided, and

guiding the user to the identified parking frame.

According to (12), the parking frame where the energy consumption is smaller than the predetermined value is identified as the parking frame to which the user is guided based on the parking statistical information including the energy consumption information and the environmental information indicating the environment during parking. Accordingly, for example, as compared with a configuration in which the user is guided to a parking frame at the shortest distance from a predetermined position or the like, it is possible to guide the user to a parking frame where the energy consumption is smaller. That is, it is possible to identify the parking frame where the energy consumption is small and to guide the user to the parking frame taking into consideration environments such as the parking environment.

1. A parking lot management device that identifies, from among a plurality of parking frames, a parking frame to which a user who wishes to use a parking lot provided with the plurality of parking frames is guided, the parking lot management device comprising:
a processor configured to:
identify, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided; and
guide the user to the identified parking frame.

2. The parking lot management device according to claim 1, wherein
the environmental information includes attribute information indicating an attribute of each vehicle, information indicating entry date and time into the parking lot, and weather information during entry into the parking lot, and
the processor is configured to identify an environment similar to an environment during entry of a vehicle of the user into the parking lot with reference to the environmental information, and identify a parking frame where the energy consumption is smaller than the predetermined value in the identified environment as the parking frame to which the user is guided to.

3. The parking lot management device according to claim 1, wherein
the environmental information further includes information indicating exit date and time from the parking lot, information indicating a congestion degree in the parking lot from entry to exit, and information indicating a change in weather from the entry to the exit.

4. The parking lot management device according to claim 2, wherein
the weather information includes at least information on weather and temperature.

5. The parking lot management device according to claim 2, wherein
the attribute information includes at least one of a vehicle size, a minimum ground clearance, a minimum turning radius, a vehicle number, an approach angle, and a departure angle.

6. The parking lot management device according to claim 1, wherein
the processor is configured to
acquire information on a parking frame selected according to a output guidance, and update the parking statistical information based on the acquired information on the parking frame, and
identify a parking frame where the energy consumption is smaller than the predetermined value as the parking frame to which the user is guided based on the updated parking statistical information.

7. The parking lot management device according to claim 1, wherein
the processor is configured to identify a parking frame where the energy consumption is smaller than the predetermined value as the parking frame to which the user is guided when a remaining energy amount of a vehicle of the user during entry into the parking lot is less than a threshold.

8. The parking lot management device according to claim 1, wherein
the processor is configured to identify a parking frame where the energy consumption is smaller than the predetermined value as the parking frame to which the user is guided when there is no available energy charging equipment in the parking lot.

9. The parking lot management device according to claim 1, wherein
the energy consumption information includes information on energy consumption of each vehicle from entering the parking lot to parking in the parking frame, information on energy consumption during parking in the parking frame, and information on energy consumption from exiting the parking frame to exiting the parking lot.

10. A parking lot management system, comprising:
the parking lot management device according to claim 1; and
a vehicle configured to communicate with the parking lot management device and receive guidance to the parking frame, wherein
the vehicle includes a second controller configured to receive the guidance to the parking frame from the parking lot management device, and notify the user of information on the parking frame based on the received guidance.

11. A parking lot management method performed by a computer, wherein
the computer identifies, from among a plurality of parking frames provided, a parking frame to which a user who wishes to use a parking lot provided with the plurality of parking frames is guided, and
the parking lot management method comprises:
identifying, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided; and
guiding the user to the identified parking frame.

12. A non-transitory computer-readable storage medium storing a program for causing a computer to execute a process, wherein
the computer identifies, from among a plurality of parking frames, a parking frame to which a user who wishes to use a parking lot provided with the plurality of parking frames is guided, and
the process comprises: identifying, based on parking statistical information including energy consumption information regarding energy consumption corresponding to each vehicle that was parked in each of the plurality of parking frames in the parking lot, and environmental information indicating an environment during parking of each vehicle, a parking frame where the energy consumption is smaller than a predetermined value as the parking frame to which the user is guided; and guiding the user to the identified parking frame.
